(19) United States
(12) Patent Application Publication
(10) Pub. No.: US 2019/0277378 A1
(43) Pub. Date: Sep. 12, 2019

(54) METHOD AND APPARATUS FOR CONVERSION OF ENERGY AND DIRECTIONAL PROPULSION USING DIRECTED IMBALANCE OF CENTRIPETAL FORCES

(71) Applicant: Walter W. Bronson, Katy, TX (US)

(72) Inventor: Walter W. Bronson, Katy, TX (US)

(21) Appl. No.: 15/913,485

(22) Filed: Mar. 6, 2018

(51) Int. Cl. F16H 25/14

(52) U.S. Cl. CPC F16H 25/14

(57) ABSTRACT

A method and apparatus for energy conversion useful for directional propulsion and using a directed imbalance of centripetal forces. In one embodiment, an apparatus is provided comprising a rigid rod having weights disposed at each end thereof. The rod is engaged by a rotatable hub disposed at a central axis point within a closed-loop track. As the hub and rod rotate, the weights are directed along the track. The shape of the track is non-circular, and the central axis point is situated within the track such that the rod is caused to slide back and forth in the hub as the hub rotates. The continuously changing radii of rotation of the weights are such that a directed imbalance of centripetal forces is created, achieving a net positive force in one direction.

### FIELD OF THE INVENTION

The present invention relates generally to the fields of energy conversion and propulsion systems, and more particularly to a method and apparatus for conversion of energy from one form to another to generate propulsive forces.

### BACKGROUND OF THE INVENTION

The movement or propulsion of a physical object in a directed path requires creation and application of a linearly-directed force. Such a force can be created or generated in countless ways. A human can move or propel an object by pushing it, i.e., applying a linearly-directed force upon the object, with sufficient force to overcome resistances created by inertia, gravity, friction, and so on, to cause movement of the object in the linear direction at which the force is applied. In such a case, the force is generated by human muscle contractions and skeletal forces. As another example, objects may be moved by mechanical means, such as when persons or objects are transported by an automobile. In the case of an automobile, the energy (force) necessary to propel objects is ultimately derived from the combustion of fuel and a mechanism for enabling explosive combustion forces (energy) that drive pistons coupled to a crankshaft. The arrangement of pistons and crankshaft thereby converts the explosive combustion forces (energy) into rotational energy of the crankshaft. This rotational energy provided from the crankshaft is applied, through a transmission consisting essentially of gears, to rotate the automobile's wheels, causing the automobile to be propelled linearly.

The harnessing and conversion of energy from one form to another to achieve useful work occurs in countless ways in the physical world.

### SUMMARY OF THE INVENTION

The present invention is directed generally to an apparatus and method for conversion of energy from one form for another, and to energy conversion resulting in creation of propulsive forces. In particular, the present invention relates to the conversion of rotational energy, such as might be provided from an electric motor, into linearly-directed energy, such as might be utilized to propel an object in a desired direction.

In accordance with one aspect of the invention, a mechanism is provided consisting of a rotor assembly that is coupled to a source of rotational energy. The rotor assembly comprises a dual, opposing set of weights that rotates in an orbit around an axis point. This axis point is “off-center” relative to the shape of the orbit to which movement of the weights is constrained, thereby purposefully creating orbital instability.

In accordance with another aspect of the invention, the orbital instability controls (1) the amount of weight that is rotating, (2) the speed of rotation, and (3) the size of the orbit, as these are the three factors in Newton's Law of Centripetal Force, which is expressed as follows:

Centripetal Force=[WEIGHT (Mass)×SPEED² (Velocity)]±RADIUS

The orbital instability of the invention causes the entire structure to lurch in a specific, controlled direction. Yet, rather than correct or compensate for instability, the invention involves harnessing and controlling the instability to achieve a net linearly-directed force driving the mechanism back and forth (on a 2-dimensional plane) and, or up and down (in a 3-dimensional space).

In one embodiment of the invention, the mechanism includes a track that constrains the weight(s) to rotate in a continuous but non-circular orbit. Since the radius or travel of one weight is shorter than the other for approximately one-half of each rotation, the centripetal force will be substantially less for one weight than for its counterpart. This results in a net surplus of centripetal force in one, prescribed, direction.

Properly situated, this apparatus is capable of creating a force that could (in a sense) overcome gravitational forces.

In one embodiment, the apparatus may be driven by electrical means, e.g., an electric motor, for imparting the necessary rotational energy to the rotating weights, thereby minimizing CO² emissions.

In accordance with one aspect of the invention, the apparatus may be silent or nearly silent in operation (excepting perhaps the noise associated with the weights being conveyed along the track), and creates no measurable emissions or backdraft. In various embodiments, the invention is fully and advantageously operable even in a zero-gravity environment.

### BRIEF DESCRIPTION OF THE DRAWINGS

The foregoing and other features and aspects of the present invention may be best understood with reference to a detailed description of at least one embodiment of the invention, when read in read in conjunction with the accompanying drawings, in which:

FIG. 1 is a top view of an energy conversion apparatus in accordance with an exemplary embodiment of the invention;

FIG. 2 is a perspective view showing a portion of the central connecting rod and a rotating hub from the apparatus of FIG. 1;

FIG. 3 is a detail view of a portion of the central connecting rod with a weight coupled to one end and riding along or against an outer track;

### DETAILED DESCRIPTION OF A PREFERRED EMBODIMENT OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such development efforts might be complex and time-consuming, outside the knowledge base of typical laymen, but would nevertheless be a routine undertaking for those of ordinary skill in the relevant fields.

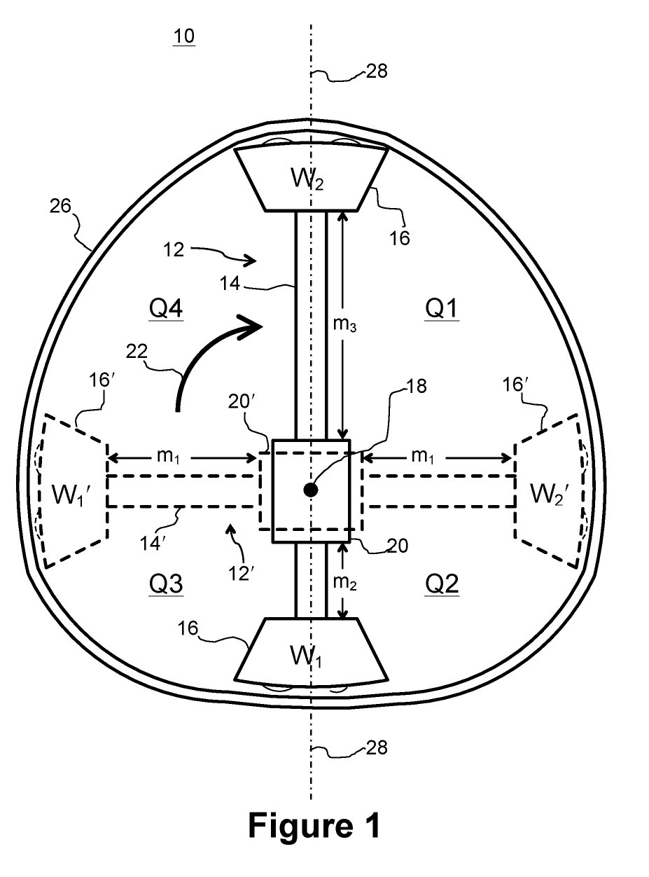

Referring to FIG. 1, there is shown a top view of an energy conversion system 10 in accordance with one embodiment of the invention. As shown in FIG. 1, the system comprises a rotor assembly 12 comprising an elongate, rigid connecting rod 14 and a pair of opposing weights 16 (also designated as W1 and W2), disposed on opposite ends of connecting rod 14.

It is first to be noted that FIG. 1 shows rotor assembly 12 in two perpendicular positions, with one of the positions being shown with dashed lines and having primed reference numerals 12′, 14′, 16′ and so on. An arrow 22 indicates the clockwise rotation of rotor assembly 12/12′ about a fixed axis point 18.

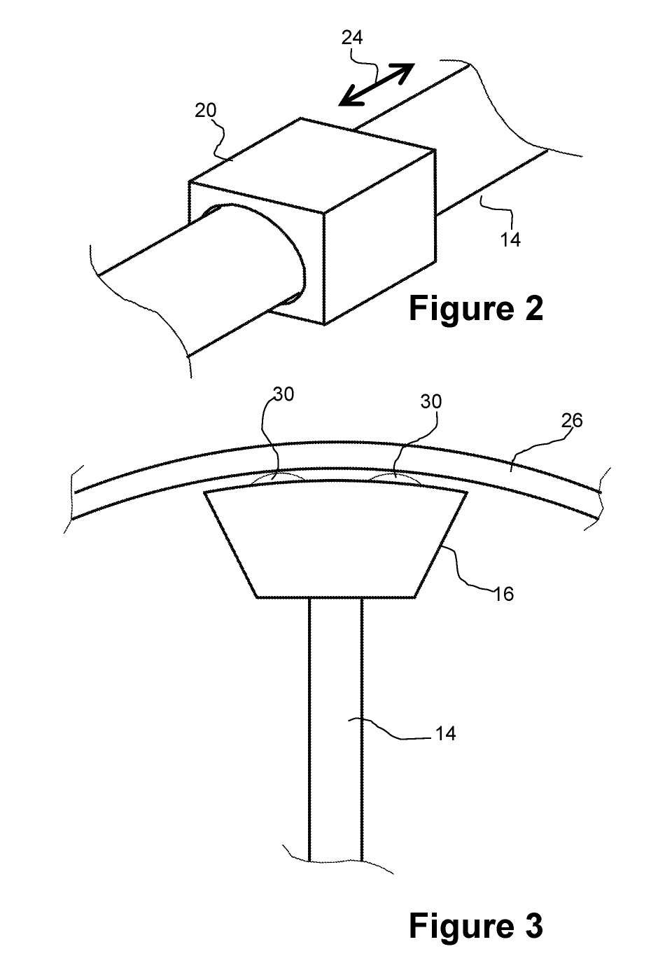

With continued reference to FIG. 1 and also to FIG. 2, the rotor assembly 12/12′ is slidably engaged by a rotating hub 20/20′ which receives an applied input of rotational energy, as will be hereinafter described. In accordance with one aspect of the invention, rod 14 is slidably engaged by hub 20, such that rod 14 can move linearly back and forth within hub 20 as indicated by arrow 24 in FIG. 2.

Referring again to FIG. 1, rotor assembly 12 is constrained both by its slidable engagement with hub 20, as well as by a track 26 which defines a closed-loop path along which weights 16 travel. In accordance with one aspect of the invention, track 26 is a continuous loop, but in a preferred embodiment is neither circular nor elliptical. Because hub 20 rotates around a fixed, non-central axis point 18, the irregular, i.e., non-circular shape of track 26 causes rod 14 to slide back and forth within hub 20 as hub 20 rotates. In the preferred embodiment, the respective weights 16 (W1 & W2) are always equi-distant from one another, being affixed to respective ends of rod 14, which is of fixed length.

The shape of track 26 in FIG. 1 is intended only to be exemplary; it is believed that variations of the shape shown may be employed in the practice of the invention. Moreover, the shape shown in FIG. 1 is not drawn to precise scale. Those of ordinary skill having the benefit of the present disclosure will recognize that the shape of track 26 is determined and/or constrained by a number of factors, each of which may vary. For instance, the shape of track 26 is partially determined by the fixed length of rod 14. The shape is further constrained or determined based upon the selected position of central axis point 18.

As shown in FIG. 1, and in accordance with one aspect of the invention, when the rotor assembly is oriented such as identified with reference numeral 12′, hub 20′ is situated substantially at the midpoint of connecting rod 14′, defining two equal moment arms m₁ corresponding to the distance between the hub 20′ and each weight 16′. The first moment arm m₁ corresponds to the distance between the first weight W₁′ and hub 20, and the second moment arm m₁ corresponds to the distance between the second weight W₂′ and the hub 20′.

With continued reference to FIG. 1, when rotor assembly 12 is in the perpendicular position (reference numeral 12), track 26 constrains the rotor assembly to be in a position where the rod 14 passes through hub 20 in an orientation which defines two unequal moment arms m₂ and m₃, where m₂ corresponds to the distance between hub 20 and weight W₁, and m₃ corresponds to the distance between hub 20 and the second weight W₂. In this orientation, m₃>m₂. However, because the length of rod 14 (and hub 20) is fixed, it follows that 2m₁=m₂+m₃, and it is apparent that m₂<m₁<m₃.

In this disclosed embodiment, moment arm m₂ represents the minimum or shortest moment arm which can occur as the rod 10 is rotated about point P, and moment arm m₃ represents the maximum which can occur. As will hereinafter be described, the orientation of rod 14 as shown in FIG. 1 defines a central axis of the apparatus, designated by dashed line 28 in FIG. 1.

As previously noted, to permit rotation of rod 14 as driven by hub 20 while weights 16 are constrained to movement along track 26, it is necessary for rod 14 to move linearly with respect to hub 20 as hub 20 rotates, as indicated by arrow 24 in FIG. 2, thereby permitting the continual variation in the length of the two respective moment arms during rotation of rod 14.

The two perpendicular orientations 12 and 12′ of rod 14 in FIG. 1 serve to define four quadrants Q1, Q2, Q3, and Q4 of the apparatus, as indicated in FIG. 1. For the purposes of the following description, a clockwise rotation of rod 14 shall be assumed, as reflected by arrow 22. In accordance with one aspect of the invention, it is apparent that whenever rod 14 is rotated such that weight W2 is in quadrant Q1, opposing weight W1 will be in quadrant Q3. Similarly when rod 10 is in a position where weight W2 is in quadrant Q2, opposite weight W1 will be in quadrant Q4.

As rod 10 rotates in a clockwise direction from position 12 toward position 12′, the moment arm associated with weight W₂ will gradually decrease in length from a length m₃ (position 12) to a shorter length m₁ (position 12′), while the moment arm associated with weight W₁ will increase from a length m₁ (position 12) to a greater length m₁ (position 12′). Those of ordinary skill in the art will appreciate that this means that the effective rotational radius for weight W₂ decreases during travel of weight W₂ through quadrant Q1, at the same time as the rotational radius for weight W₁ increases during travel of weight W₁ through quadrant Q3.

Conversely, and although not depicted for purposes of clarity in the drawings, as rod 14 continues rotating clockwise from position 12′ to a position where the weight identified as W₁′ in FIG. 1 advances to the position held by weight W₂ in FIG. 1 (i.e., one-half of a complete rotation of hub 20 and rod 14), the moment arm associated with weight W₁ will continue increasing in length from length m₂ to a length m₃, while the moment arm associated with weight W₂ will continue decrease in in length from a length m₁ to a length m₂. This means that the effective rotational radius for weight W₁′ increases during travel of weight W₁′ through quadrant Q4 at the same time as the effective rotational radius of weight W₂′ decreases during travel of weight W₂′ through quadrant Q2.

As will be appreciated by those of ordinary skill, the overall effect of the arrangement depicted in FIG. 1 is that the effective centripetal forces exhibited by weights W₁ and W₂ are unbalanced, with each weight's moment arm (and hence, radius of rotation for the purposes of Newton's Law of Centripetal Force set forth above) gradually increases as each respective weight travels (clockwise) through quadrants Q3 and Q4, and gradually decreases as each respective weight travels (clockwise) through quadrants Q1 and Q2.

Those of ordinary skill in the relevant field(s) will recognize and appreciate that this cyclical modulation of the moment arms of the respective weights 16 can be mathematically shown to lead to a net positive imbalance of centripetal force directed as indicated by directional dashed center line 28.

Because weights 16 are in constant contact with track 26 as they rotate, the net positive centripetal force resulting from the rotation is transferred from the weights to track 26. In this way, the directed imbalance of centripetal force tends to propel the apparatus as a whole in the direction of the imbalance.

In accordance with one aspect of the invention, it is contemplated that any of numerous sources of rotational energy may be utilized in connection with the practice of the invention. An electric motor is believed to be a source of rotational energy that is particularly suitable for the purposes of the invention. The manner of coupling of any particular source of rotational energy to hub 20 may vary depending upon the particular implementation and the type of rotational energy source employed. In the case of an electric motor, for example, it is contemplated that the motor's rotating shaft may be coupled directly to hub 20, or could possibly be coupled by means of pulleys, gears, belts, or the like. The present invention is not believed to be limited with respect to the particular type of rotational energy source employed or the manner by which such rotational energy is applied to the energy conversion apparatus described herein.

Those of ordinary skill in the art will appreciate that in the embodiment as described, the energy conversion efficiency of the apparatus can be optimized by reducing and minimizing friction wherever it is preset in the system. One source of friction in the system exists between the weights 16 and track 26 as weights 16 rotate around/along track 26. In the exemplary embodiment, one approach to minimizing the frictional interaction between weights 16 and track 26 is to provide one or more rollers or bearings on said weights. Such an approach is depicted in FIG. 3, which shows a detail of a weight 16 at the end of rod 14 and contacting track 26. In this exemplary embodiment two bearings or rollers 30 are provided. The roller(s)/bearing(s) 30 are able to minimize friction while at the same time enabling centripetal forces to be transmitted from weights 16 to track 26.

Another potential source of friction occurs at the slidable engagement of rod 14 with hub 20, which is shown in detail in FIG. 2. Those of ordinary skill in the art will appreciate how roller or linear bearings may be provided internally to hub 20 to minimize frictional forces as rod 14 slides back and forth within hub, as described above.

Those of ordinary skill in the art will also appreciate that the overall performance of the apparatus disclosed herein can be influenced by the particular shape of track 26 along with the selection of location of central axis point 18 within track 26. As will be appreciated by persons of ordinary skill having the benefit of this disclosure, these two factors (track shape and location of central axis) are effectively determinative of the lengths of the moment arms associated with the rotation of weights 26 around the axis point 18. These moment arms continuously vary in length according to a complex function (which depends upon the shape of track 26) as the weights rotate around track 26. Thus, the centripetal force (mass×velocity/radius) of each weight at any given time during operation of the apparatus will itself be a complex function ultimately depending upon the length of rod 14, the shape of track 26, and the placement of central axis point 18. It will be appreciate, therefore, that this function can be adjusted and/or optimized for a given implementation.

It is to be understood that various implementation details as described herein are provided for illustrative purposes only, and are not to be considered limiting with respect to the scope of the invention. For example, whereas in the disclosed embodiment, rod 14 is described and depicted as having an elongate dowel-like (cylindrical) configuration, this is by no means the only suitable configuration. A bar having a substantially square or rectangular cross-section might be equally suitable. Likewise, the particular shape and configuration of weights 16 described and depicted in this disclosure is not considered to be a necessary feature.

Those of ordinary skill in the relevant field(s) having the benefit of the present disclosure will further appreciate that the various components of the system may be fabricated out of a wide variety of different materials, as may be appropriate for any particular implementation of the invention. Those of ordinary skill will also appreciate that the choices of materials may be made with particular consideration to a number of factors, including the minimization of friction between moving parts of the system. For example, materials suitable for construction of the hub may include metals or plastics having relatively low frictional properties, in order to minimize frictional forces and thus maximum energy conversion efficiency. Of course, strength and weight considerations must also be taken into account.

Although a particular embodiment of the invention has been described herein in some detail, it is to be understood that this has been done solely for the purposes of illustrating the invention in its various aspects. It is contemplated and to be explicitly understood that various substitutions, alterations, and/or modifications, including but not limited to any such implementation variants and options which may have been specifically noted or suggested herein, including inclusion of technological enhancements to any particular method step or system component discovered or developed subsequent to the date of this disclosure, may be made to the disclosed embodiments of the invention without necessarily departing from the technical and legal scope of the invention as defined in the following claims.

What is claimed is:

1. A method for conversion of rotational energy into linearly-directed energy, comprising:
providing a rotor assembly including an elongate rod having first and second ends and having a first weight coupled to said first end and a second weight coupled to said second end;
slidably engaging said rotor assembly in a rotatable hub;
orienting said hub and rotor assembly at a fixed predetermined position within a closed-loop track such that said first and second weights are guided by said track as said hub and said rotor assembly are rotated, said rotation of said rotor assembly defining an orbital plane;
applying rotational energy to said hub to cause rotation of said hub and said rotor assembly;
wherein said fixed predetermined position is such that as each weight moves around said track, its radial distance from said hub cyclically varies from a minimum to a maximum distance, said varying distance being accommodated by said slidable engagement of said rotor assembly with said hub;
and wherein said cyclical variation of distance between said weights and said hub results in a directed imbalance in centripetal force, said directed imbalance in centripetal force being applied to said track.

2. A method in accordance with claim 1, wherein said step of applying rotational energy comprises coupling an electric motor to said hub.

3. An energy conversion apparatus, comprising:
a rotor assembly including an elongate rod having first and second ends and having a first weight coupled to said first end and a second weight coupled to said second end;
a rotatable hub, adapted to receive an input of rotational energy and slidably engaging said rotor assembly, said hub and rotor assembly being oriented at a fixed predetermined position within a closed-loop track such that said first and second weights are guided by said track as said hub and said rotor assembly are rotated, said rotation of said rotor assembly defining an orbital plane;
wherein rotational energy applied to said hub causes rotation of said hub and said rotor assembly;
and wherein said fixed predetermined position is such that as each weight moves around said track, its radial distance from said hub cyclically varies from a minimum to a maximum distance, said varying distance being accommodated by said slidable engagement of said rotor assembly with said hub;
and wherein said cyclical variation of distance between said weights and said hub results in a directed imbalance in centripetal force, said directed imbalance in centripetal force being applied to said track.

4. An energy conversion apparatus in accordance with claim x, further comprising:
an electric motor providing said input of rotational energy.
